(19) United States
(12) Patent Application Publication
(10) Pub. No.: US 2024/0370395 A1
(43) Pub. Date: Nov. 7, 2024

(54) AXI-TO-MEMORY IP PROTOCOL BRIDGE

(71) Applicant: Altera Corporation, San Jose, CA (US)

(72) Inventor: Estelle KAO, San Jose, CA (US)

(21) Appl. No.: 18/777,991

(22) Filed: Jul. 19, 2024

(51) Int. Cl. G06F 13/40; G06F 13/42

(52) U.S. Cl. CPC G06F 13/4027; G06F 13/4234

(57) ABSTRACT

An Advanced extensible Interface (AXI)-to-memory IP protocol bridge and associated apparatus and methods. The protocol bridge includes a first interface configured to be coupled to Write Address (AW), Write Data (W), Write Response (B), Read Address (AR) and Read Data (R) channels for the AXI manager and to implement AW, W, B, AR, and R signaling in accordance with an AXI protocol. A second interface is configured to couple I/O signals with the memory IP, with the I/O signals including a memory IP input channel to convey input data and input addresses with first I/O control signals, and a memory IP output channel to receive output data from the memory IP with second I/O control signals. The protocol bridge also includes logic for bridging the AXI protocol used by the AW, W, B, AR, and R signaling with a protocol used by the memory IP I/O signals.

### BACKGROUND INFORMATION

The Advanced extensible Interface (AXI) is an on-chip communication bus protocol and is part of the Advanced Microcontroller Bus Architecture specification (AMBA). The AXI interface specification defines the interface of intellectual property (IP) blocks, rather than the interconnect itself.

The AXI protocol has several features that are designed to improve bandwidth and latency of data transfers and transactions. These include independent read and write channels: AXI supports two different sets of channels, one for write operations, and one for read operations. Having two independent sets of channels helps to improve the bandwidth performances of the interfaces since read and write operations can happen at the same time.

The AXI protocol allows for multiple outstanding addresses. This means that a manager can issue transactions without waiting for earlier transactions to complete. This can improve system performance because it enables parallel processing of transactions. With AXI, there is no strict timing relationship between the address and data operations. This means that, for example, a manager could issue a write address on the Write Address channel, but there is no time requirement for when the manager has to provide the corresponding data to write on the Write Data channel.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram illustrating the AXI channels used by an AXI manager and AXI subordinate, as defined by the AXI specifications;

FIG. 2 is a schematic diagram illustrating a controller architecture 200 including an SoC (System on Chip) or NoC (Network on Chip) coupled to memory IP, according to one embodiment;

FIG. 3 is a table listing the signals and associated information used by the controller architecture of FIG. 2, according to one embodiment;

FIG. 4 is schematic diagram 400 illustrating an instantiation of sixteen 0.5 MB datablocks (DBs), according to one embodiment;

FIG. 5 shows a diagram illustrating conventional and proposed refresh timing schemes associated with the DB architecture of FIG. 4, according to one embodiment;

FIG. 6 is a schematic diagram illustrating an architecture including an AXI manager, a memory IP, and an AXI-to-memory IP protocol bridge, according to one embodiment;

FIG. 7 is a flowchart illustrating operations performed by the architecture of FIG. 6 when performing memory reads, according to one embodiment;

FIG. 8 is a flowchart illustrating operations performed by the architecture of FIG. 6 when performing memory writes, according to one embodiment;

FIG. 9 is a schematic diagram illustrating a first package architecture under which the AXI manager and protocol bridge are integrated on an SoC coupled to a memory IP, according to one embodiment;

FIG. 10 is a schematic diagram illustrating a second package architecture under which the AXI manager is integrated on an SoC, and the protocol bridge is integrated on a die or chip coupled to the SoC that includes the memory IP, according to one embodiment;

FIG. 11 is a schematic diagram illustrating a third package architecture under which the AXI manager, protocol bridge, and memory IP are integrated on an SoC, according to one embodiment; and

FIG. 12 is a block diagram of a scalable integrated circuit package in accordance with an embodiment.

### DETAILED DESCRIPTION

Embodiments of an Advanced eXtensible Interface (AXI)-to-memory IP protocol bridge and associated apparatus and methods are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

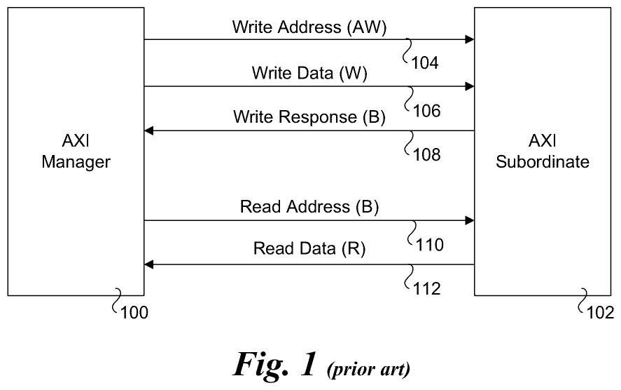

As shown in FIG. 1, the AXI specification describes a point-to-point protocol between two interfaces: an AXI manager 100 and an AXI subordinate 102. There are five main channels that each AXI interface uses for communication. For write operations AXI manager 100 sends an address on a Write Address (AW) channel 104 and transfers data on a Write Data (W) channel 106 to subordinate 102. AXI Subordinate 100 writes the received data to the specified address. Once the subordinate has completed the write operation, it responds with a message to the manager on a Write Response (B) channel 108.

For Read operations AXI manager 100 sends the address it wants to read on a Read Address (AR) channel 110 to AXI subordinate 102. The subordinate sends the data from the requested address to the manager on a Read Data (R) channel 112. The subordinate can also return an error message on Read Data (R) channel 112. An error occurs if, for example, the address is not valid, or the data is corrupted, or the access does not have the right security permission.

Each channel is unidirectional, so a separate Write Response channel is needed to pass responses back to the manager. However, there is no need for a Read Response channel because a read response is passed as part of the Read Data channel.

### Controller Architecture and Sub-Blocks

The memory controller executes loads and stores and refresh operations based on a rotating time slot access pattern. A fully associative load store queue enables buffering random or sequential accesses to maximize bandwidth utilization. In one embodiment, an 8 MB memory space formed by 16 physical 0.5 MB half datablocks (DBs) that are subdivided into 16 logical 0.5 MB memory regions that are interleaved and mapped to the 4 lower address bits to maximized sequential access performance. The current time slot/memory region that can be serviced is based on a 4b counter that is always incrementing. The time slot access abstraction allows all memory datablock timing constraints to be abstracted as rotating access to 16 separate memory regions, in one embodiment.

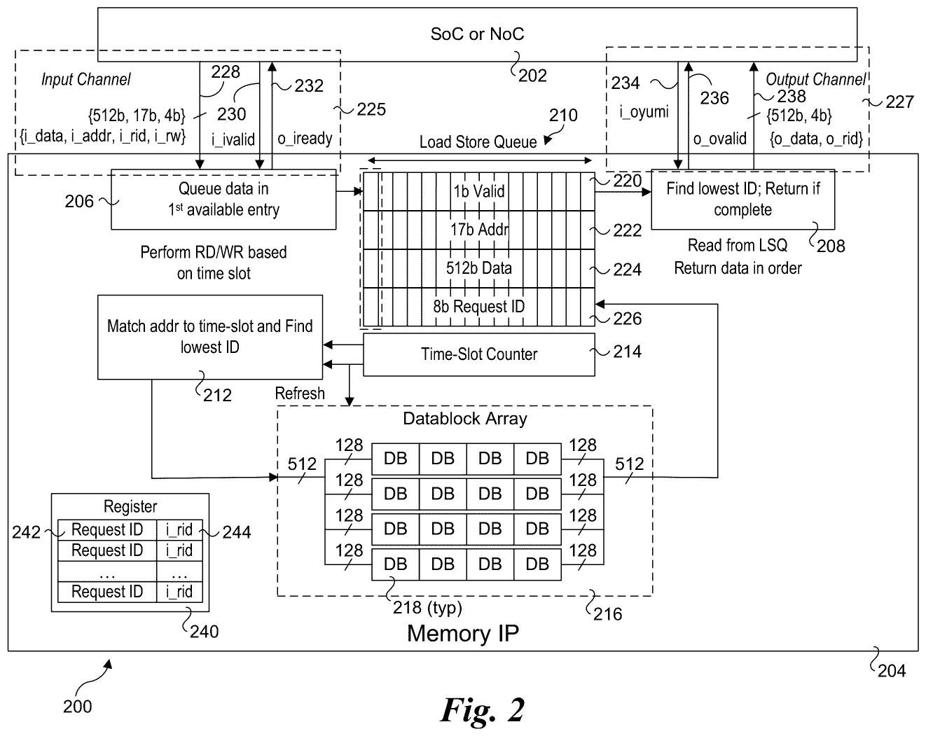

FIG. 2 shows a controller architecture 200 including an SoC (System on Chip) or NoC (Network on Chip) 202 coupled to memory IP 204. Memory IP 204 includes a pair of interfaces 206 and 208, a fully associative load store queue (LSQ) 210, a logic block 212, a time-slot counter 214, and a datablock array 216 comprising an array of DBs 218. LSQ 210 includes buffers 220, 222, 224, and 226.

For illustrative purposes and simplicity, the size of the buffers 220, 222, 224, and 226 are shown to have the same size in the Figures herein. In the illustrated embodiment, the size of the buffers 220 are 1 bit, with each entry/slot enqueuing a 1-bit valid flag. Buffers 222 are used to enqueue 17b addresses. Buffers 224 are used to enqueue 512b of data. Buffers 226 are used to enqueue 8b request identifiers (IDs) in the illustrated embodiment. In another embodiment buffers 226 enqueue 4b request IDs.

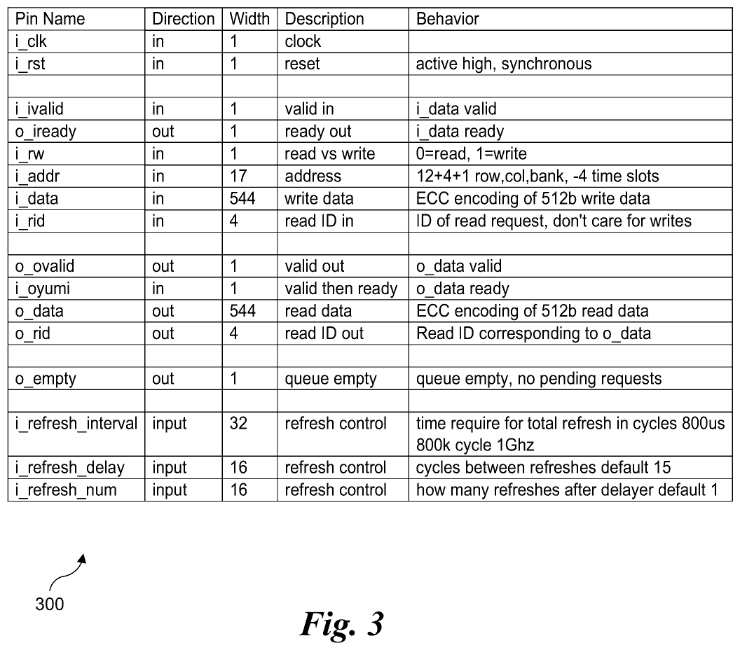

Architecture 200 further includes multiple input/output (I/O) signals transmitted between SoC or NoC 202 and interfaces 206 and 208, while further details of the I/O signals are shown in table 300 in FIG. 3. The I/O signals received by and transmitted from interface 206 comprise an input channel 225, and include a data/address input signal 228, an i_ivalid (valid in) signal 230, and a o_iready (ready out) signal 232. The I/O signals received by and transmitted from interface 208 comprise an output channel 227 and include an i_oyumi (valid then ready) signal 234, an o_ovalid (valid out) signal 236, and an o_data (output data) signal 238. Data/address input signal 228 is used to send write data (i_data) comprising 512b and a 17b address (i_addr). i_ivalid signal 230 is a 1b input signal indicating valid data. o_iready signal 232 is a 1b output signal indicating the output is ready. i_oyumi signal 234 is a 1b signal input signal indicating input side is ready to receive valid and ready data. o_ovalid signal 236 is an output signal indicating the data are valid, with o_data signal 238 comprising 512b of output data.

As shown in Table 300 in FIG. 3, in one embodiment the 512b or read and write data are encoded using error correction code (ECC) encoding, which in one embodiment comprises 544b. Accordingly, the width or the portion of the buses used for conveying data in the input and output channels is 544 rather than 512. As will be recognized by those skilled in the art, various ECC encoding schemes may be used that may result in encoded data that is something other than 544b. Under an alternative implementation, ECC encoding is not used.

Operation for controller architecture 200 is divided into 4 actions. 1) Enqueuing read and write requests. 2) Performing memory reads and writes. 3) Buffering memory read data. and 4) Dequeuing read and write requests.

Enqueuing read and write requests includes the following. Requests from the SoC or NoC 202 are written to LSQ 210 for processing by the memory controller. The requests are issued with internally-generated request IDs in sequential order. The requests are written to the first available open entry in LSQ 210. In one embodiment, this is implemented as a simple priority encoder, but could be performed in other ways. If the LSQ is full, then the controller de-asserts the o_iready signal and applies backpressure to the uNoC. Data is accepted to LSQ 210 when both i_ivalid and o_iready are high. There is no combinational path dependence between o_iready and i_ivalid.

For reads and writes, requests are selected from LSQ 210 and processed in time slot order using time-slot counter 214. On each clock cycle, only memory reads/writes for a particular time slot can be performed. LSQ 210 is treated as a fully associative buffer during this action. The controller searches for the LSQ entry with the lowest (request) ID that is also valid and matches the current time slot. These requests are sent to the memory (e.g., an applicable DB 218 in datablock array 216).

Buffering read data proceeds as follow. For reads, the memory returns data to LSQ 210 10 TCLKs (in one embodiment) after the read request is selected. The read data is written back into LSQ 210 into the data field of the corresponding read request (identified by the request ID). Data buffers in LSQ 210 can be re-used for both write and read operations. In one embodiment, read data from the memory is always accepted by LSQ 210. The buffer space is pre-allocated by the read request.

### Dequeuing Read and Write Requests

Processed requests are selected from LSQ 210 and sent to SoC or NoC 202. The processed requests are sent in order based on their request ID. While individual 512b memory accesses can be processed out of order, the operation appears to be fully in-order to the SoC or NoC. If LSQ entries are allocated in order, then finding the entry to dequeue is based on simple rotating priority with the oldest ID selected among request addresses corresponding to the current time slot. The dequeuing circuits search for the LSQ entry with the lowest ID that has completed processing. This data is sent to the SoC or NoC when both o_ovalid and i_oyumi are high. In one embodiment, there is no combinational path dependence between o_ovalid and i_oyumi.

In the illustrated embodiment the signals for input channel 225 includes a read ID in (i_rid) signal and output channel 227 includes a read ID out (o_rid) signal. As shown in table 300 in FIG. 3, in one embodiment both i_rid and o_rid are 4b wide. i_rid and o_rid are used to map an input read request to its (read) output data. In one embodiment, the i_rid is transmitted in parallel with i_addr and i_rw. In one embodiment, the o_rid is transmitted in parallel with o_data.

Various mechanisms can be used to map i_rids to o_rids. For example, in one embodiment memory IP 204 includes a register 240 with multiple fields in which Request IDs 242 and associated i_rids 244 are written). Under one implementation, in connection with issuance of a new Request ID, the Request ID and the i_rid associated with the read request written to a free entry in register 240. As data is read out (e.g., read from the LSQ), a lookup of register 240 is made using the Request ID, and the i_rid in the associated entry is read and the entry is marked as free. The i_rid becomes the o_rid to be used when the block of read data is transferred to the protocol bridge via the output channel.

### Sub-Blocks

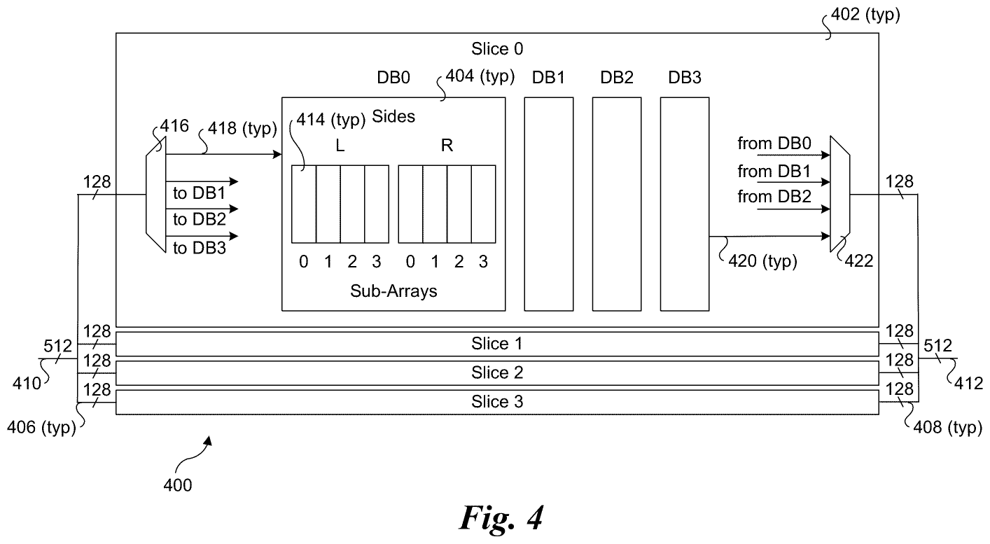

The primary sub-blocks in the memory IP include memory half datablocks, the time slot counter, and the LSQ. FIG. 4 shows a diagram 400 illustrating an instantiation of sixteen 0.5 MB DBs, along with corresponding charge pumps. The hierarchy of the memory is as follows. The controller is designed to control a 4×4 array of half datablocks organized as four slices 402 with each slice containing 4 DBs 404. The four slices are also labeled Slice 0, Slice 1, Slice 2, and Slice 3 in FIG. 4. Each slice 402 has a 128b data input 406 and a 128b output 408. The slices are accessed in parallel and 128b data from each slice is concatenated to form the 512b input 410 to the memory sub-block and the 512b output 412 from the memory sub-block. Each slice contains a charge pump to supply wordline and bitline voltages (not separately shown).

Within each slice 402 there are four DBs 404. The DBs are accessed one at a time, in a time multiplexed manner. Each DB 404 contains two sides ((L)eft and (R)ight). Each side contains four sub-arrays 414. On the input side, circuitry 416 is used to receive 128b of input data for the slice and split this input into four 32b data portions 418 that are respectively input to DB0, DB1, DB2, and DB3. On the output side, 32b data outputs 420 from DB0, DB1, DB2, and DB3 are combined by circuitry 422 to form 128b outputs 408.

As shown in architecture 200 in FIG. 2 above, interfaces 206 and 208 facilitate communicates between the SoC or NoC and the memory IP, with associated operations used to enqueue and buffer data using LSQ 210, which is the centralized request queue and data buffer for the controller. The time slot counter controls which read/write requests can access the DBs on a given clock cycle. In one embodiment, the time slot counter increments over 16 time slots continuously. During each time slot, a specific DB, DB side (left, right), and even/odd sub-array is accessed. For example, in time slot 0, accesses to DB0, left side, even subarrays are allowed. In time slot 1, accesses to DB1, left side, even sub-arrays are allowed. And so on. The time slots ensure that timing constraints within the memory are met. Once 16 cycles have elapsed, the pattern is repeated since at that time accesses to the same sub-array are once again allowed.

In one embodiment, memory addresses are striped across the DB sub-arrays, such that sequential addresses are distributed across DBs, DB sides, and sub-arrays. For example, addresses with (i_addr[3:0]==0) are stored in DB0, left side, sub-array 0, and accessed during time slot zero.

### Refresh Control

Refresh logic issues reads to the DBs on a fixed schedule. Refresh operations take priority over read/write requests stored in the LSQ and consume the current timeslot with a read-based refresh command. The number of refresh time slots could be as high as 1 per every 17 clock cycles. In this manner, the sequence of time slots would be 0, 1, 2, . . . , 14, 15, Refresh, 0, 1,. . . . In one embodiment, refresh is implemented as a dummy read to the memory. The dummy read address is incremented for each refresh, such that over a period of time, all memory locations are refreshed. During refresh cycles, regular reads/writes are stalled. The number of refresh cycles can be adjusted to minimize latency while still meeting data refresh requirements.

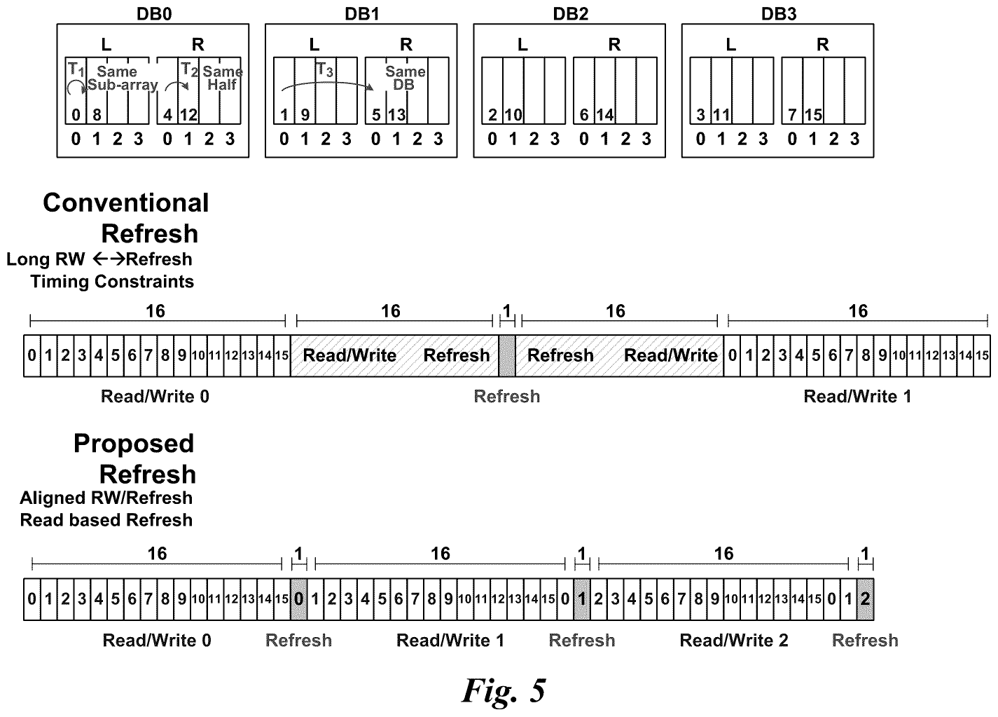

As shown in FIG. 5, the time slot method utilizing read-based refresh provides benefits over conventional refresh using the built-in DB refresh command. For conventional refresh, the relationship between regular read/write addresses and refresh location is unknown. Thus, there must be a 16-cycle delay between regular read/write and refresh to avoid timing constraints. This requirement would increase 1 KB read/write latency if refresh occurs during the read. Bounded deterministic latency would increase by >32 cycles if conventional refresh is used. The default refresh config is i_refresh_delay=15 i_refresh_num=15. Alternative settings should be analyzed carefully to ensure latency bounds and refresh interval completion.

FIG. 5 further shows three cycles of an aligned Read/Write-Refresh pattern using the proposed refresh scheme. Each Read/Write takes 16 clock cycles, followed by a Refresh that occurs during a single clock cycle. This scheme provides substantial improvement over the conventional refresh scheme.

As further examples, the following three sequences take the same duration to process:

TABLE 1

| | |
|---|---|
| WR only | WR(addr = 0) −> WR(addr = 1) −> |
| | WR(addr = 2) −> WR(addr = 3) −> WR(addr = 4) |
| RD only | RD(addr = 0) −> RD(addr = 1) −> |
| | RD(addr = 2) −> RD(addr = 3) −> RD(addr = 4) |
| WR/RD mix | WR(addr = 0) −> RD(addr = 1) −> |
| | WR(addr = 2) −> RD(addr = 3) −> WR(addr = 4) |

Each address is assigned a time slot and is only allowed to be executed when the timestamp matches the time slot number. If no requests are pending for the time slot, then it is treated as an idle cycle.

### AXI-to-Memory IP Protocol Bridge

In accordance with aspects of the embodiments below, an AXI-to-memory IP protocol bridge is disclosed that utilizes the input and output data queues inherent to the memory controller, serializes write and read transactions and map them to the AXI interface protocol without requiring additional arbiters, infrastructure logic or unique RAM blocks. This is achieved, in part, by repurposing the queuing buffers in the memory IP discussed above as the arbiter logic and reordering the AXI signals to match the write/read protocol implemented by the memory IP.

By leveraging the unique time-slot counter characteristics and input and output queue designs, we can simplify the AXI-to-memory IP protocol bridge as a conversion medium. The bridge acts as an AXI subordinate to translate the memory specific signals as AW/W/B/AR/R AXI signals. The five AXI sub-channels (Write Address, Write Data, Write Response, Read Address, and Read Data) with handshake signals (valid, ready) are serialized into a pair of input and output channels to interface with the controller on the memory IP. The AXI valid and ready signals are generated as the memory IP receives or transmits requested data.

In one embodiment, the Write and Read transactions are streamlined into a single FIFO input queue with a label indicating if the request is a write or read. This eliminates the need for write/read arbitration. The read responses are returned in-order using a FIFO output queue (LSQ 210) to maintain compliance with AXI ordering should a memory location be accessed multiple times.

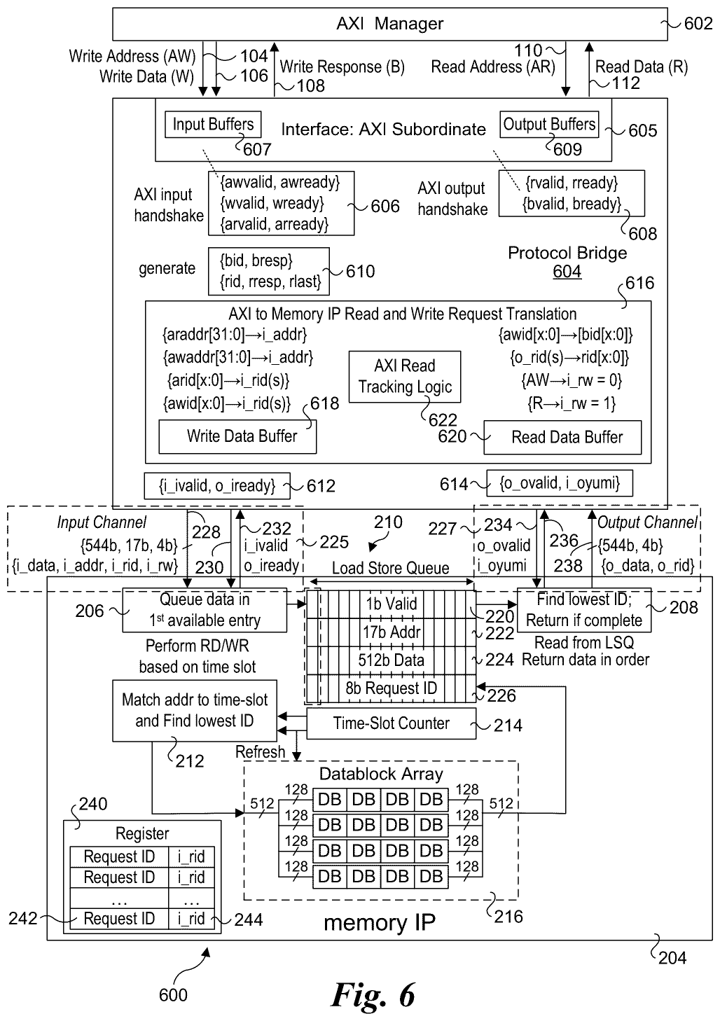

FIG. 6 shows an architecture 600 including an AXI manager 602, an (AXI-to-memory IP) protocol bridge 604 including an interface 605 comprising an AXI subordinate, and memory IP 204 having the same structure shown in FIG. 2 and discussed above. Protocol bridge 604 is configured to operate as an AXI-to-memory IP protocol bridge, thereby providing an interface between AXI manager 602, which employs an AXI protocol, with memory IP 204, which employs a different protocol. Interface 605 includes I/O inputs buffers 607 and I/O output buffers 609.

As with the AXI manager and AXI subordinate in FIG. 1, architecture 600 includes AXI channels AW 104, W 106, B 108, AR 110, and R 112 coupled between AXI manager 602 and interface 605. From the perspective of AXI manager 602, protocol bridge 604 is an AXI subordinate, and AXI manager 602 is agnostic to the functionality performed by protocol bridge 604 to enable AXI manager 602 to access memory in memory IP 204 using an AXI protocol.

As mentioned above, protocol bridge 604 operates as a conversion medium between AXI manager 602 and memory IP 204. The conversion includes both protocol conversions (from AXI to the protocol used by memory IP 204) and physical signal structure conversion (the signal structures used for the AXI channels and the signal structures used for the memory IP input and output channels are different).

To support one of more AXI protocols (e.g., AXI3 and/or AXI4), interface 605 implements AXI valid and ready handshake signals for each of the AW 104, W 106, B 108, AR 110, and R 112 AXI channels. For example, the AXI valid and ready handshake signals for AW {awvalid, awready}, W (wvalid, wready), and AR {arvalid), arready} shown in block 606 comprise AXI input handshake signals. The valid and ready handshake signals for AXI memory Read Data (R) {rvalid, ready} and Write Response (B) {bvalid, bready} are shown in block 608 and comprises AXI output handshake signals.

As shown in block 610, in addition to the aforementioned AXI valid and ready handshake signals there are sets of signals that are generated by protocol bridge 604 to support AXI write responses and AXI read data. These include {bid, bresp} for write responses, and {rid, rresp, and rlast} for read data.

For input channel 225, protocol bridge 604 implements {i_ivalid,o_ready} signals shown in block 612 and for output channel 227 protocol bridge implements {o_ovalid, i_oymi} signals shown in block 614.

Protocol bridge 604 is also configured to perform AXI to memory IP read and write request translation operations, as shown in a block 616. The translation operations include,
{araddr[31:0]→i_addr};
{awaddr[31:0]→i_addr};
{arid[x:0]→i_rid(s)};
{awid[x:0]→i_rid(s)};
{awid [x:0]→[bid[x:0]}; and
{o_rid(s)→rid[x:0]}
{AW→i_rw=0}
{R→i_rw=1}
   Block 616 further includes one or more write data buffers 618, one or more read data buffers 620, and AXI read tracking logic 622.

In one embodiment, data/address input signal 228 includes signals lines to convey both input data and an input address in parallel using a single set of control signals. Thus, whereas AW 104 and W 106 are separate subchannels under the AXI protocol, the corresponding data conveyed via these subchannels may be transmitted from protocol bridge 604 to memory IP 204 over a single input channel 225 comprising a parallel bus including (in the illustrated embodiment) 544 signal lines for i_data, 17 signal lines for i_addr, 4 signal lines the i_rid, and one signal line each for i_rw, i_ivalid, and o_iready. Similarly, output channel 227 comprises a parallel bus including (in the illustrated embodiment) 544 signal lines for o_data, 4 signal lines for the o_rid, and one signal line each o_ovalid, and i_oyumi.

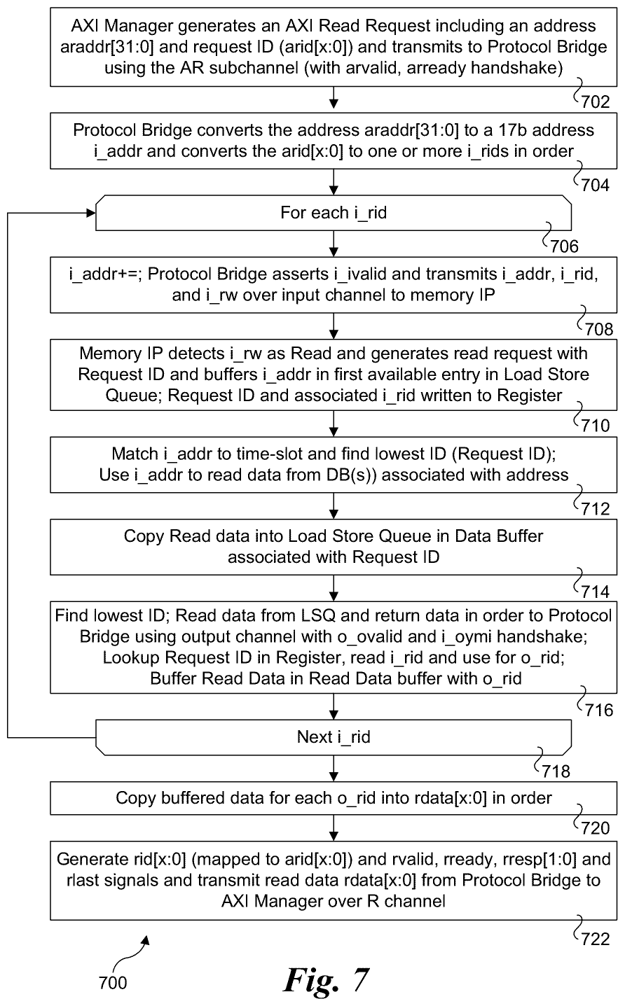

FIG. 7 shows a flowchart 700 illustrating operations for performing an AXI memory read of memory in memory IP 204, according to one embodiment. The process begins in a block 702 with the AXI manager generating a 32-bit AXI read address araddr[31:0] and a request ID (arid[x:0]) and transmits these data to the protocol bridge via the AR subchannel. Prior to transmission, handshake signals for the AR subchannel (arvalid, arready) are exchanged.

In addition to the address and request ID, other AR channel signals may be used, including but not limited to size (arsize[2:0]), length (arlen[3:0] for AXI3 and arlen[7:0]), arburst[1:0], and arcache[3:0]. However, for simplicity, these AR channel signals are not separately shown or further described in this example.

In a block 704, the protocol bridge converts the address araddr[31:0] to a 17b address i_addr and converts the arid[x: 0] to one or more i_rids, depending on the size of the memory read request. As shown in FIG. 3, in one embodiment the 17b address is split into 12b, 4b, and 1b respectively corresponding to a row, column (col) and bank. It is noted that while AXI supports 32b addresses, logic for performing the address translation would translate the memory IP address to an address range supported by a given memory IP. Thus, in one embodiment, for a given instance of the protocol bridge and memory IP, the range of the 32b AXI address space would not exceed the 17b address space supported by the memory IP. In another embodiment (not shown), a memory IP may include multiple instances of datablock array 216, and the memory IP address comprises 18b.

The memory Reads and Writes for memory IP use a block size of 512b, in one embodiment. For requests for larger amount of data, the protocol bridge and memory IP are configured to support AXI AR signals used for multiple read requests in a single AXI transaction and/or using an AXI burst mode. The protocol bridge and memory IP are configured to break the requested data into 512b blocks with respective i_rids and (for the memory IP) and serialize the request (using the request IDs). This will enable the protocol bridge to return multiple blocks of read data in the same order corresponding to the Read requests originating from the AXI manager. Again, from the perspective of the AXI manager, it is communicating with an AXI subordinate using AXI signaling and an AXI protocol and is agnostic to how the read data are accessed behind the scenes.

In some instances, an AXI memory read request will be for 512b of data, which corresponds to 64 Bytes (64 B) of data and is a common size of a cache line in some cache/memory architectures. In other cases, the AXI memory read request may be a multiple of 512b, such as 1024b, 2048b, etc. In these cases, there will be an i_rid generated for each 512b block of the requested read data.

As shown by start and end loop blocks 706 and 718, the operations in blocks 708, 710, 712, 714, and 716 are performed for each i_rid that is generated. In block 708 the i_addr associated with the current i_rid is offset to point to the memory IP address for the current block of 512b of read data. For the first pass through the address is not offset. The protocol bridge asserts i_ivalid and transmits i_addr, i_rid and i_rw (cleared to ‘0’ for Read) over the input channel (data/address input signal 228) to memory IP 204. In a block 710 logic in interface 206 on memory IP 204 detects (using i_rw) this is a read request and issues a request ID and queues the Request ID and i_addr in the first available entry in load store queue 210. Since this is a Read, there will be no data written to a data buffer 224 associated with the request ID at this time, but rather a data buffer 224 will be associated with the request ID to be subsequently filled with the read data. The Request ID and its associated i_rid are written to a free entry in register 240.

As shown in a block 712 and logic block 212 on memory IP 204, the address i_addr will be matched to a time-slot and the lowest request ID will be found. In conjunction with the matching time-slot, data in the DB(s) for i_addr will be read, with the read data being copied to the data buffer 224 associated with the request ID, as depicted in a block 714.

In a block 716, the lowest request ID will be found by logic in interface 208 on memory IP 204. If the logic determines the read is complete, the logic will read the data from the LSQ associated with the lowest request ID and return the data in request order to the protocol bridge via output channel 227 using the o_ovalid and i_oymi handshake signals. A lookup of register 240 is performed using the request ID, with the associated i_rid being read and used for the o_rid for the read data transfer. As further shown in FIG. 6 the read data will be transmitted as o_data with the o_rid over the output data signal 238. The read data is buffered in read data buffer 620. The logic then proceeds to end loop block 718 and returns to start loop block 706 to being operations for the next i_rid and to read the next 512b of data.

As shown in a block 720, after all the read data associated with the one or more i_rids have been received and buffered in read data buffer 620, the buffered data is copied into a buffer as rdata[x:0] in order. For example, one of output buffers 609 may be used for this.

The process is memory read process is completed in a block 722 by generating an rid[x:0] and generating rvalid, rready, resp[1:0] and rlast signals (as appropriate) and use the rvalid and rready signals as handshake signals to transmit the read data and rid[x:0] from the protocol bridge over the AXI Read Data (R) channel to AXI manager 602.

Under the AXI protocol, ARIDs (arid[x:0] are mapped to RIDs (rid[x:0]). Accordingly, protocol bridge 604 provides a mechanism for this that is illustrated as AXI read tracking logic 622. When an arid is received, a determination is made to how many 512b blocks of data will be read. That information is stored in AXI read tracking logic 622 as an arid and associated count. i_rids and o_rids are also mapped and tracked. As each 512b block of data is read, returned to the protocol bridge, and buffered in read data buffer 620, and the count is decremented. After completion of the one or more reads of 512b corresponding to an AXI arid[x:0], the count will be zero and the corresponding read data will be copied to one of output buffers 609 as described above.

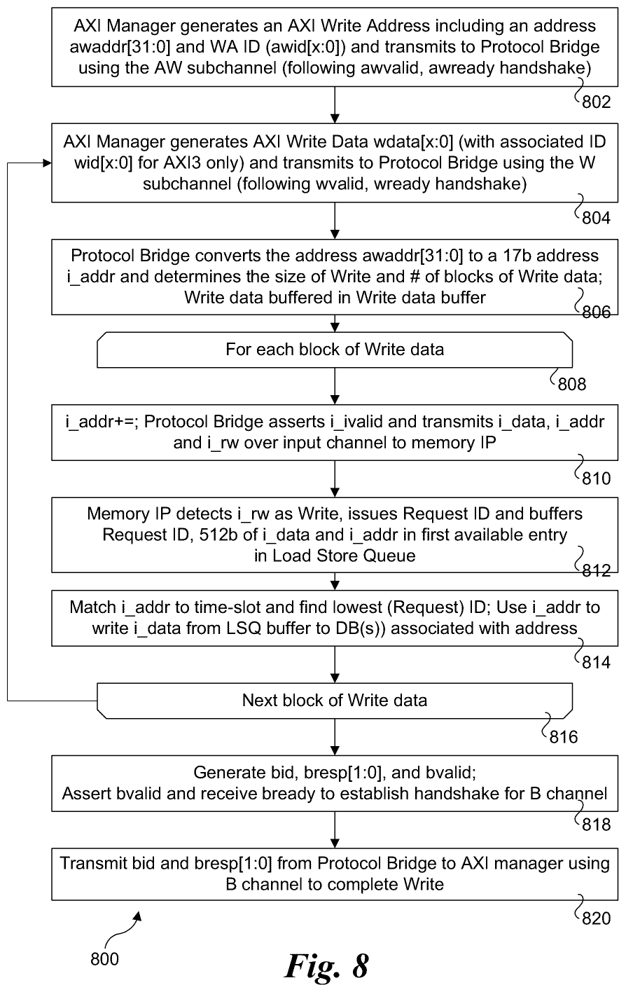

FIG. 8 shows a flowchart 800 illustrating operations for performing an AXI memory write to memory in memory IP 204, according to one embodiment. The process begins in a block 802 with the AXI manager generating an AXI write address awaddr[31:0] and AW ID (awid[x:0]) and transmits these data to the protocol bridge via the AW subchannel. Prior to transmission, handshake signals for the AW subchannel (awvalid, awready) are exchanged.

In addition to the AW address and AWID, other AW channel signals may be used, including but not limited to size (awsize[2:0]), length (awlen[3:0] for AXI3 and awlen[7:0]), awburst[1:0], and awcache[3:0]. However, for simplicity, these AW channel signals are not separately shown or further described in this example.

In a block 804 the AXI manager generates AXI write data wdata[x:0] with (for AXI3 only) associated WID (wid[x: 0]) and transmits these data to the protocol bridge via the W subchannel. Prior to transmission, handshake signals for the W subchannel (wvalid, wready) are exchanged.

In a block 806, the protocol bridge converts the address awaddr[31:0] to a 17b address i_addr in a manner similar to that described above for read addresses. The size of the write request is determined from wdata[x:0], and the number of 512b blocks of data that will be written is calculated. As with reads, an AXI write may involve multiples of one or more 512b blocks. The write data (wdata[x:0]) is buffered in write data buffer 618.

As shown by start and end loop blocks 808 and 816, the operations of blocks 810, 812, and 814 are performed for each 512b of block data. In block 810 i_addr is offset to point to the current block of write data, with the offset being 0 the first pass through. The protocol bridge asserts i_ivalid and transmits the current block of 512b of wdata as i_data, i_addr, and i_rw (set to ‘1’ for Write) over the input channel (data/address input signal 228) to memory IP 204. Logic in interface 206 on memory IP 204 detects (using i_rw) this is a Write request and queues these data in the first available entry in load store queue 210. This includes issuing a request ID and writing the request ID to a buffer 226, copying the 512b of i_data to a data buffer 224, and copying the i_addr to a buffer 222 in LSQ 210, as is depicted in a block 812.

As shown in a block 814 and logic block 212 on memory IP 204, the address i_addr will be matched to a time-slot and the lowest request ID will be found. In conjunction with occurrence of the matching time-slot, the i_data in buffer 224 associated with the request ID will be written to the DB(s) for i_addr.

The logic will then proceed to end loop block 816 and loop back to start loop block 808 to begin processing the next block of write data. The sequence is repeated until all the one or more blocks of write data have been written to the memory IP. For each sequential block of write data, i_addr will be offset to point to the current block.

In one embodiment, the memory IP does not return a confirmation for write completions, as it is assumed the writes will be successful. However, under AXI protocols, confirmation of write request is required. This is done using the BID (bid) signal. Accordingly, the protocol bridge will then generate a bid, bresp[1:0] and bvalid AXI signals in a block 818 and assert bvalid and receive bready to establish the handshake on the B (Write Response) channel. The write process is completed in a block 820 with the protocol bridge transmitting bid and bresp[1:0] using the B channel to AXI manager 602. It is noted that while the operations of block 818 and 820 appear after end loop block 816, the operations in blocks 818 and 820 may be asynchronous to operations within the loop.

As with AXI reads, the AXI3 and AXI4 protocols support Write transactions including multiple blocks of data, as well as burst modes. For these use cases the protocol bridge will serialize corresponding write data requests, split the read data into one or more 512b block and submit associated write requests for each block to the memory IP comprising. The protocol bridge will also generate bids for each of the AXI write request and return the bids to the AXI manager to confirm completion of the write transactions. Again, from the perspective of the AXI manager, it is communicating with an AXI subordinate using AXI signaling and an AXI protocol and is agnostic to how the write data are written to memory on the memory IP behind the scenes.

As discussed above, in one embodiment the 512b of read and write data are encoded using TECQED encoding, which comprises 544b when encoded. For simplicity, in flowcharts 700 and 800 and the accompanying description above, the data transfers by the input and output channels are described as conveying 512b of data. When TECQED encoding is used, the 512b of data is encoded as 544b and 544b of data is conveyed for each data transmission. Accordingly for transfers using TECQED, 512b of data will be encoded prior to being transmitted from the protocol bridge to the memory IP using encoding logic on the protocol bridge, transmitted via the input channel, and will be decoded back to 512b data using decoding logic on the memory IP. For data transmissions from the memory IP to the protocol bridge over the output channel, 512b of data will be encoded to 544b using logic on the memory IP prior to transmission and decoded back to 512b once received using logic in the protocol bridge.

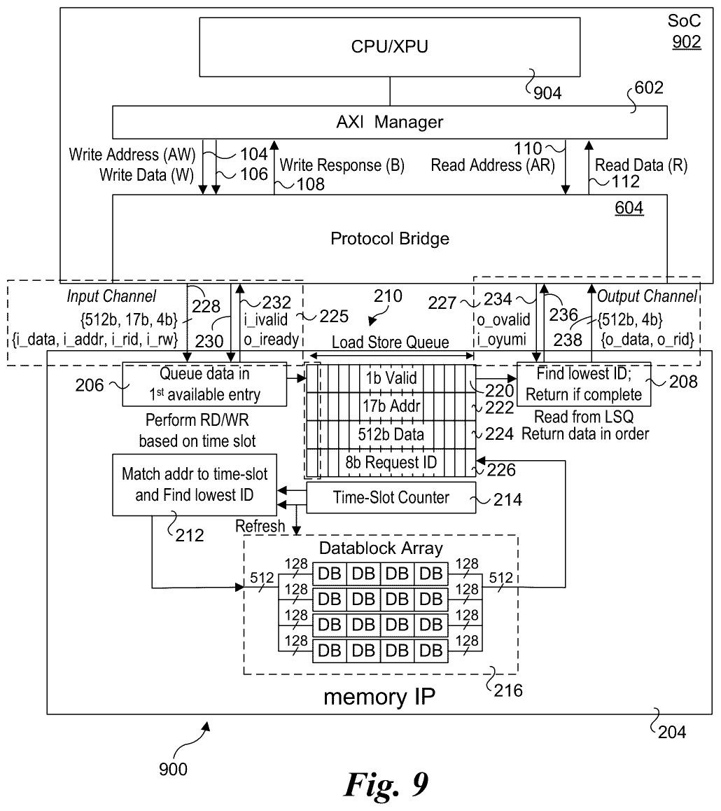

Generally, the circuitry shown in the embodiments described and illustrated herein may be packaged using different packaging schemes, including single chip, multi-chip or multi-die packages, and 3D packages. FIG. 9 shows a first packaging embodiment of a package 900 under which AXI manager 602 and protocol bridge 604 are integrated on an SoC 902 including a CPU or XPU 904 with the SoC being separate from memory IP 204. For example, SoC 902 and memory IP 204 may comprise separate chips or separate dies that may be in the same plane or arranged on top of one another in a 3D package. Generally, XPUs (“Other Processing Units”) include one or more of Graphic Processor Units (GPUs) or General Purpose GPUs (GP-GPUs), Tensor Processing Units (TPUs), Data Processing Units (DPUs), Infrastructure Processing Units (IPUs), Artificial Intelligence (AI) processors or AI inference units and/or other accelerators, FPGAs and/or other programmable logic (used for compute purposes), etc. In some embodiments and SoC or System on Package (SoP) may include a CPU and one or more XPUs. Moreover, as used in the following claims, the term “processor unit” is used to generically cover CPUs and various forms of XPUs.

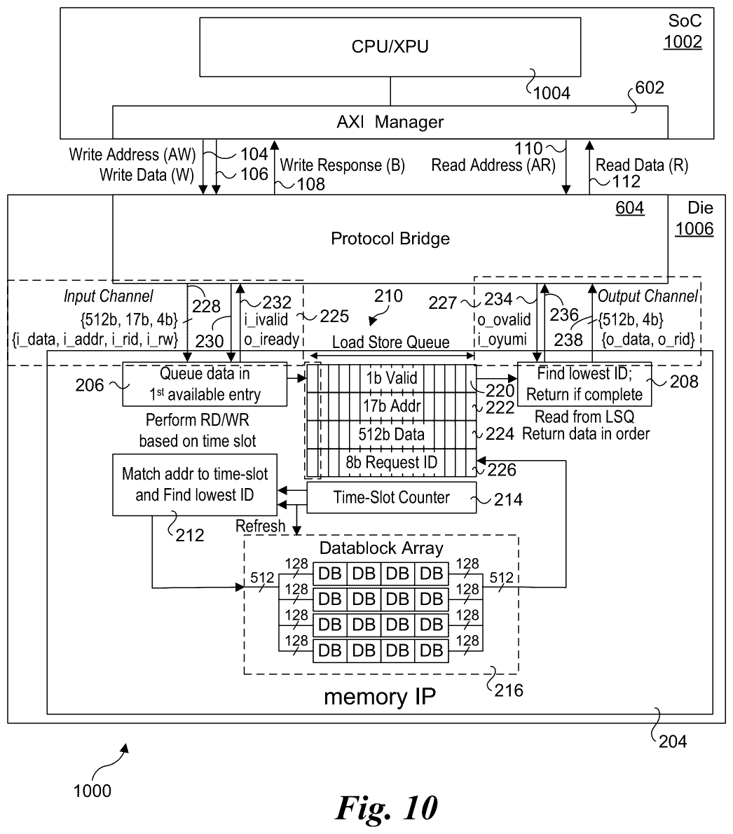

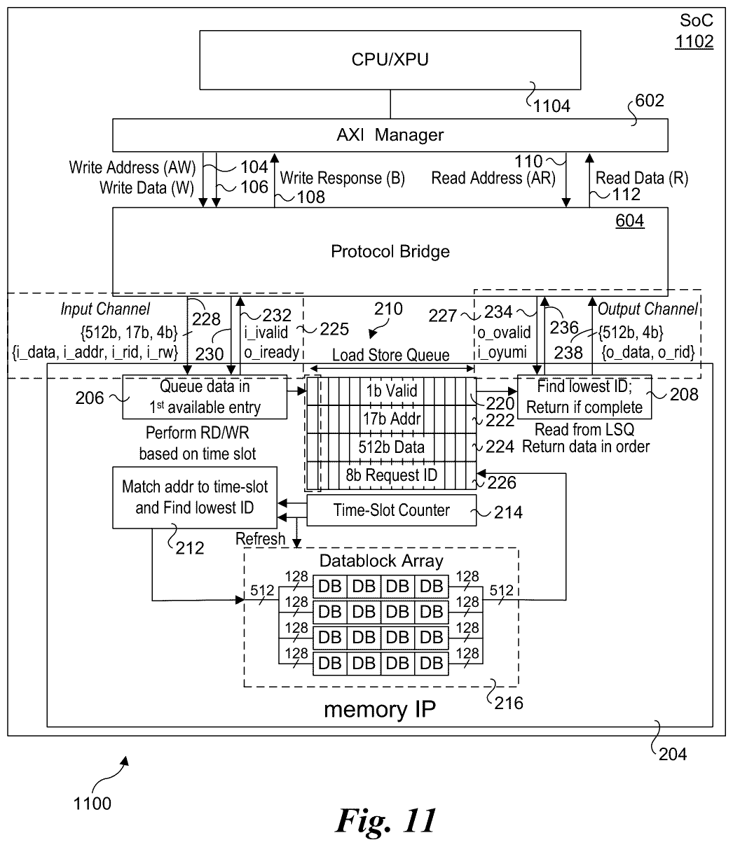

FIG. 10 shows a package 1000 under which AXI manager 602 is integrated on an SoC 1002 including a CPU/XPU 1004, while protocol bridge 604 and memory IP 204 are integrated on a die or chip 1006. As with package 1000, Soc 1002 and die/chip 1006 may be on the same plane or one top of one another in a 3D package. Under the packaging embodiment shown in FIG. 11, all of CPU/XPU 1104, AXI manager 602, protocol bridge 604, and memory IP 204 are integrated on an SoC 1102.

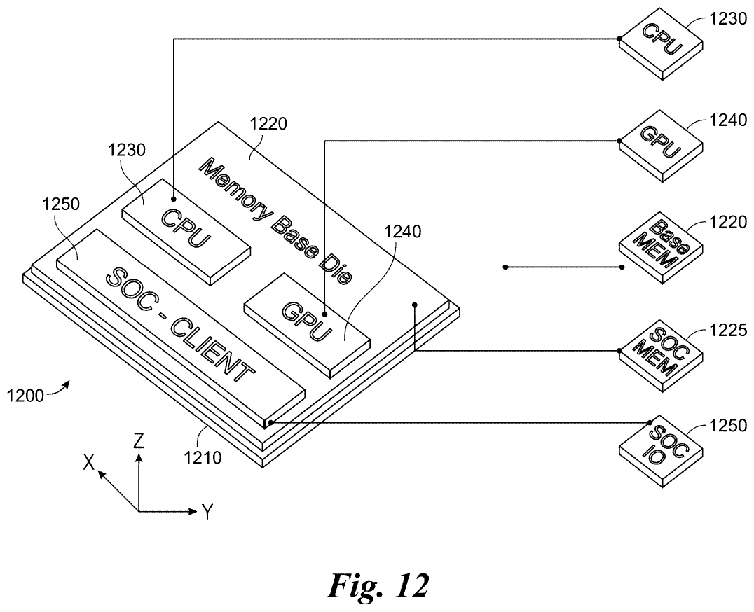

Referring now to FIG. 12, shown is a block diagram of a scalable integrated circuit (IC) package 1200 in accordance with an embodiment. As shown in FIG. 12, package 1200 is shown in an opened state; that is, without an actual package adapted about the various circuitry present. In the high level shown in FIG. 12, package 1200 is implemented as a multi-die package having a plurality of dies adapted on a substrate 1210. Substrate 1210 may be a glass or sapphire substrate and may, in some cases, include interconnect circuitry to couple various dies within package 1200 and to further couple to components external to package 1200.

In the illustration of FIG. 12, a memory die 1220 is adapted on substrate 1210. In some embodiments herein, memory die 1220 may comprise a memory IP die and/or be a disaggregated memory side cache.

As further shown in FIG. 12, multiple dies may be adapted above memory die 1220. As shown, a CPU die 1230, a GPU die 1240, and an SoC die 1250 all may be adapted on memory die 1220. SoC memory 1225 may be integrated in memory dies 1220. FIG. 12 further shows in inset these disaggregated dies, prior to adaptation in package 1200. CPU die 1230 and GPU die 1240 may include a plurality of general-purpose processing cores and graphics processing cores, respectively. In some use cases, instead of a graphics die, another type of specialized processing unit (such as an XPU) may be present. Regardless of the specific compute dies present, each of these cores may locally and directly couple to a corresponding portion of memory die 1220. For example, in one embodiment through silicon vias (TSVs) may be used. In addition, CPU die 1230 and GPU die 1240 may communicate via interconnect circuitry. Similarly, additional circuitry of an SoC, including interface circuitry to interface with other ICs or other components of a system may occur via circuitry of SoC die 1250.

While shown with a single CPU die and single GPU die, in other implementations multiple ones of one or both of CPU and GPU dies may be present. More generally, different numbers of CPU and XPU dies (or other heterogenous dies) may be present in a given implementation.

In some embodiments, memory IP may be implemented in a system architecture as an embedded dynamic random access memory (eDRAM). In some embodiments, such eDRAM may be implemented as a 4^{th} level (L4) cache. In some embodiments, the L4 cache may be on the same die or SoC as other caches (e.g., L1/L2 and L3 caches). In other embodiments, the L4 cache may be implemented on a separate die or chip from the SoC.

While various embodiments described herein use the term System-on-a-Chip or System-on-Chip (“SoC”) to describe a device or system having a processor and associated circuitry (e.g., I/O circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., I/O circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

The memory on the memory IP comprises volatile memory. Volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3) JESD79-3F, originally published by JEDEC (Joint Electronic Device Engineering Council) in June 2007. DDR4 (DDR version 4), JESD209-4D, originally published in September 2012, DDR5 (DDR version 5), JESD79-5B, originally published in June 2021, DDR6 (DDR version 6), currently in discussion by JEDEC, LPDDR3 (Low Power DDR version 3, JESD209-3C, originally published in August 2015, LPDDR4 (LPDDR version 4, JESD209-4D, originally published in June 2021), LPDDR5 (LPDDR version 5, JESD209-5B, originally published in June 2021), WIO2 (Wide Input/Output version 2), JESD229-2, originally published in August 2014, HBM (High Bandwidth Memory, JESD235B, originally published in December 2018, HBM2 (HBM version 2, JESD235D, originally published in March 2021, HBM3 (HBM version 3, JESD238A originally published in January 2023) or HBM4 (HBM version 4), currently in discussion by JEDEC, or others or combinations of memory technologies, and technologies based on derivatives or extensions of such specifications. The JEDEC standards are available at www.jedec.org.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. An apparatus comprising an Advanced extensible Interface (AXI)-to-memory Intellectual Property (IP) protocol bridge configured to be implemented as an AXI subordinate disposed between an AXI manager and a memory IP and comprising circuitry including:
a first interface configured to be coupled to Write Address (AW), Write Data (W), Write Response (B), Read Address (AR) and Read Data (R) channels for the AXI manager and to implement AW, W, B, AR, and R signaling in accordance with an AXI protocol;
a second interface configured to couple Input/Output (I/O) signals with the memory IP, the I/O signals including,
a memory IP input channel including one or more input signals to convey an input data and an input address, and first I/O control signals;
a memory IP output channel including an output signal received from the memory IP to convey output data, and second I/O control signals; and
logic for bridging the AXI protocol used by the AW, W, B, AR, and R signaling with a protocol used by the memory IP I/O signals.

2. The apparatus of claim 1, wherein the first I/O control signals includes a valid input and a ready output signal, and wherein the logic for bridging the AXI protocol used by the AW, W, B, AR, and R signaling with a protocol used by the memory IP I/O signals includes logic for equating {awvalid, awready}, {wvalid, wready}, and {arvalid, arready} AXI protocol signals with the valid input and ready output signals on a pairwise basis.

3. The apparatus of claim 1, wherein the second I/O control signals includes a valid output and an output data ready signal, and wherein the logic for bridging the AXI protocol used by the AW, W, B, AR, and R signaling with a protocol used by the memory IP I/O signals includes:
logic for respectively equating rvalid and ready AXI protocol signals with the valid output and the output data ready signal.

4. The apparatus of claim 1, further comprising logic to generate {bid, bresp, bvalid, bready} data and signals utilized with the AXI Write Response channel.

5. The apparatus of claim 1, further comprising logic to generate {rid, rresp, rlast} AXI data and signals utilized with the AXI Read Data channel.

6. The apparatus of claim 1, wherein the input data and output data comprise 512 bits.

7. The apparatus of claim 1, wherein the apparatus comprises a processing unit comprising circuitry for implementing the AXI manager and the AXI-to-memory IP protocol bridge.

8. The apparatus of claim 1, wherein the memory IP comprises a chip or die and wherein the AXI-to-memory IP protocol bridge is integrated the memory IP chip or die.

9. The apparatus of claim 1, wherein the memory IP comprises embedded Dynamic Random Access Memory (eDRAM).

10. An apparatus comprising:
a processing unit, having one or more processing elements and including circuitry configured to implement an Advanced extensible Interface (AXI) manager;
a memory Intellectual Property (IP) device, including a controller and memory; and
an AXI-to-memory IP protocol bridge, comprising an AXI subordinate and configured to be disposed between an AXI manager and a memory IP, the AXI-to-memory protocol bridge comprising circuity including:
a first interface configured to be coupled to Write Address (AW), Write Data (W), Write Response (B), Read Address (AR) and Read Data (R) channels for the AXI manager and to implement AW, W, B, AR, and R signaling in accordance with an AXI protocol;
a second interface configured to couple Input/Output (I/O) signals with the memory IP, the I/O signals including,
a memory IP input channel including one or more input signals to convey an input data and an input address, and first I/O control signals;
a memory IP output channel including an output signal received from the memory IP to convey output data, and second I/O control signals; and
logic for bridging the AXI protocol used by the AW, W, B, AR, and R signaling with a protocol used by the memory IP I/O signals.

11. The apparatus of claim 10, wherein the processing unit comprises a chip or die, and the AXI-to-memory IP protocol bridge circuity is integrated on the chip or die for the processing unit.

12. The apparatus of claim 11, wherein the memory IP comprises a chip or a die, and the AXI-to-memory IP protocol bridge circuity is integrated on the chip or die for the memory IP.

13. The apparatus of claim 10, wherein the first I/O control signals includes a valid input and a ready output signal, and wherein the logic for bridging the AXI protocol used by the AW, W, B, AR, and R signaling with a protocol used by the memory IP I/O signals includes logic for equating {awvalid, awready}, {wvalid, wready}, and {arvalid, arready} AXI protocol signals with the valid input and ready output signals on a pairwise basis.

14. The apparatus of claim 10, wherein the second I/O control signals includes a valid output and an output data ready signal, and wherein the logic for bridging the AXI protocol used by the AW, W, B, AR, and R signaling with a protocol used by the memory IP I/O signals includes:
logic for respectively equating rvalid and ready AXI protocol signals with the valid output and the output data ready signal.

15. The apparatus of claim 10, wherein the AXI-to-memory IP protocol bridge further comprises logic to generate {bid, bresp, bvalid, bready} data and signals utilized with the AXI Write Response channel.

16. The apparatus of claim 10, wherein the AXI-to-memory IP protocol bridge further comprises logic to generate {rid, rresp, rlast} AXI data and signals utilized with the AXI Read Data channel.

17. The apparatus of claim 10, wherein the memory IP employs a load store queue used for buffering the input data and the output data.

18. A method for facilitating memory access requests originating from Advanced extensible Interface (AXI) manager of memory on a memory intellectual property (IP), comprising:
coupling a first interface of an AXI-to-memory IP protocol bridge to the AXI manager, the first interface communicating with the AXI manager using AXI Write Address (AW), Write Data (W), Write Response (B), Read Address (AR) and Read Data (R) channels in accordance with an AXI protocol;
coupling a second interface on the AXI-to-memory IP protocol bridge to the memory IP, the second interface including an input channel used to provide input data, address data, and associated information to the memory IP and including an output channel used to receive output data and associated information from the memory IP protocol; and
performing protocol conversion operations via the AXI-to-memory IP protocol bridge to enable the AXI manager to read data from and write data to memory on the memory IP using the AXI protocol.

19. The method of claim 18, wherein protocol conversion operations performed for a memory read or memory write include converting a 32-bit memory address received from the AXI manager to a 17-bit memory address employed by the memory IP.

20. The method of claim 18, further comprising implementing a load and store queue on the memory IP, the load and store queue used to buffer memory address, request identifiers, and data associated with memory read and memory write requests.
